(19) United States
(12) Patent Application Publication
(10) Pub. No.: US 2004/0049393 A1
(43) Pub. Date: Mar. 11, 2004

(54) Automated delivery of audio content to a personal messaging device

(76) Inventors: Dave Duran, Oakland, CA (US); Jim Sturtevant, Sunnyvale, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/366,108

(22) Filed: Feb. 13, 2003

Related U.S. Application Data
(60) Provisional application No. 60/409,111, filed on Sep. 9, 2002.

(51) Int. Cl. G10L 21/00

(52) U.S. Cl. 704/275

(57) ABSTRACT

One preferred embodiment of the present invention provides a system for delivering audio content to a user, such as a young child. Briefly described, in architecture, one embodiment of the system, among others, can be implemented as follows. A messaging server stores audio content that has been designated for a particular personal messaging device. The personal messaging device polls the messaging server to determine if there is any audio content for the particular personal messaging device. If such audio content is present, the messaging server delivers the audio content to the personal messaging device over a telephone network. In a subsequent time thereafter, the personal messaging device polls the server again for audio content. Methods and other systems are also provided.

### CROSS-REFERENCE TO RELATED APPLICATION

This application claims priority to copending U.S. provisional application entitled, “WABI Enhancements Functional Specifications V0.4,” having serial No. 60/409,111, filed Sep. 9, 2002, which is entirely incorporated herein by reference.

### TECHNICAL FIELD

The present invention is generally related to a messaging system, and, more particularly, is related to a personal messaging device that stores and plays audio messages that are received via a communication network.

### BACKGROUND OF THE INVENTION

Today, families and friends are often separated by great physical distances. However, the advent of personal communication technologies, such as the cellular telephone, email, instant messaging, etc., has helped to keep families and friends in touch and in frequent communication. While these technologies are easily accessible by many persons, they are not accessible to other persons, such as toddlers and preschool children. Consequently, some persons, such as younger children, have been excluded in the revolution of personal communication.

Therefore, there is a need for a personal communication device that is easily accessible for receiving communications from family and friends. While there are some communication devices that are targeted to younger children, for example, many of these devices involve receiving communications over a computer or involve placing a telephone call to the child's home phone number and then leaving a message on the child's personal communication device, if no other family member answers the call. These techniques are cumbersome and/or inefficient methods for delivering a message to the user of the communication device, such as a young child.

Thus, a heretofore unaddressed need exists in the industry to address the aforementioned deficiencies and inadequacies in delivery of personal messages.

### SUMMARY OF THE INVENTION

Preferred embodiments of the present invention provide systems and methods for delivering audio content to a user, such as a young child. Briefly described, in architecture, one embodiment of the system, among others, can be implemented as follows. A messaging server stores audio content that has been designated for a particular personal messaging device. The personal messaging device polls the messaging server to determine if there is any audio content for the particular personal messaging device. If such audio content is present, the messaging server delivers the audio content to the personal messaging device over a telephone network. In a subsequent time thereafter, the personal messaging device polls the server again for audio content.

The present invention can also be viewed as providing methods for delivering audio content to a user, such as a young child. In this regard, one embodiment of such a method, among others, can be broadly summarized by the following steps: storing audio content; determining if audio content is present; delivering audio content if the audio content is present; and playing the audio content.

Other systems, methods, features, and advantages of the present invention will be or become apparent to one with skill in the art upon examination of the following drawings and detailed description. It is intended that all such additional systems, methods, features, and advantages be included within this description and be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of system for delivering audio content to a personal messaging device of one preferred embodiment of the present invention.

FIG. 2 is a block diagram of the personal messaging device utilized in the system of FIG. 1

FIG. 3 is a block diagram of a base station utilized in the system of FIG. 1.

FIG. 4 is a flow chart describing the functionality of a representative implementation of the system of FIG. 1 where the personal messaging device has been powered up.

FIG. 5 is a flow chart describing the functionality of a representative implementation of an interactive voice response interface to a messaging server utilized in the system of FIG. 1.

FIG. 6 is a flow chart describing the functionality of a representative implementation of the messaging server in the system of FIG. 1 for answering an incoming telephone call.

FIG. 7 is a flow chart describing the functionality of a representative implementation of the personal messaging device in the system of FIG. 1 for polling the messaging server.

FIG. 8 is a block diagram of an implementation of the messaging server in the system of FIG. 1 using a digital computer system.

### DETAILED DESCRIPTION OF THE PREFERRED EMBODIMENTS

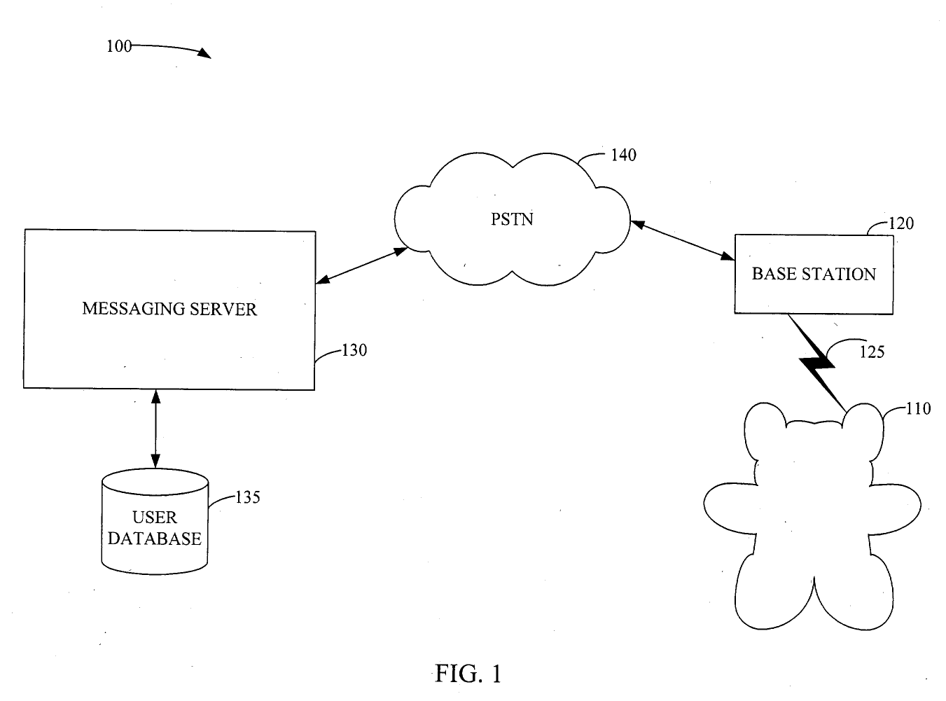

Depicted in FIG. 1 is one preferred embodiment of a personal messaging device 110 of the present invention. As illustrated, the personal messaging device 110, in this embodiment, is in the form of a plush teddy bear. Within the interior of the teddy bear 110 are electronics that enable the functionality of the bear as a messaging device for a user, such as a young child. In other embodiments of the invention, the personal messaging device 110 may be in other forms besides a plush teddy bear.

In the embodiment represented in FIG. 1, the personal messaging device 110 operates within a personal messaging system 100 for delivering messages via a toy to a user. The system 100 comprises the personal messaging device 110 which communicates to a base station unit 120 via radio waves. The base station unit 120 is connected to a messaging server 130 via the public switched telephone network (PSTN) 140. The messaging server 130 may access a user database 135 that stores messages or other audio content and user settings for the personal messaging device 110.

Generally, a user may connect to the messaging server 130 over the PSTN network 140 and leave a voice message or audio story directed to a particular personal messaging device 110. The message and other audio content is stored on the database 135 by the messaging server 130. Afterwards at predetermined times, the personal messaging device 110 communicates with the messaging server 130 over the PSTN network 140 and receives the audio content that has been stored for the personal messaging device 110.

After the message has been received, the personal messaging device 110 alerts the user of the personal messaging device 110 (e.g., a young child) that new audio content has been received so that the user may play the new audio content contained on the personal messaging device 110 by, for example, pressing the paw of the personal messaging device 110 (when the personal messaging device 110 is in the form of a teddy bear).

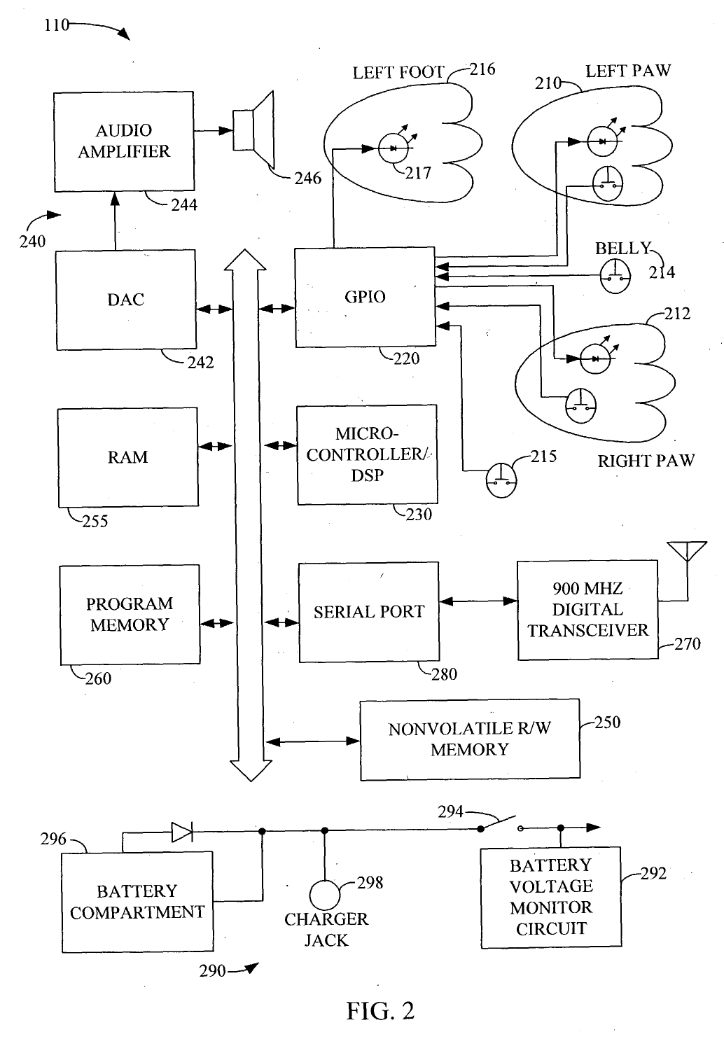

As shown in FIG. 2, the personal messaging device 110 has electronic controls and circuitry that are in the interior of the device that enable the device 110 to receive and play audio data. For example, for the embodiment where the personal messaging device 110 is in the form of a teddy bear, as shown in FIG. 2, the personal messaging device 110 may have controls that are in the paws 210, 212 and the belly 214 of the plush toy and an indicator in one of the feet 216 for a low battery. Each of these controls may then be connected to general purpose 10 ports 220 that can be read by a microcontroller 230.

There is also an audio section 240 inside the personal messaging device 110 so that audio content that is stored digitally in memory 250 can be passed through a digital/analog converter (DAC) 242 and played via an amplifier 244 and speaker 246. The messaging format utilized by the personal messaging device is all analog, so a modem is not necessary to communicate with the server 130. The messaging server 130 can either transfer data in the form of audio information for playback to the user, or data in the form of digital (Hexadecimal or BCD equivalents of 16 “key” DTMF) information to set features up and configure the personal messaging device 110 for altered functionality.

Also inside the device 110, program memory 260 stores the code that the microcontroller 230 executes to control the electronics of the personal messaging device 110. Also, as previously mentioned, non-volatile memory 250 stores the audio messages that are played via the device 110. There is also an RF section 270 for communicating with the base station unit 120. The RF section 270 may comprise a 900 MHz digital transceiver and is accessible by an 10 port 280. Other transmission techniques may be used such as digital transmissions utilizing 2.4 GHz or digital spread spectrum (DSS), and analog transmissions, among others.

Power is provided to the personal messaging device 110 via a power supply section 290. Either rechargeable or alkaline batteries may be used as a source of power. For rechargeable batteries (such as NiCad), there is a charger jack 298 for connecting to the base station unit 120 for recharging purposes. Also, the power level of the batteries can be monitored via a battery monitoring circuit 292 that is connected as an input to the microcontroller 230. If the battery power is getting low, the microcontroller 230 turns on a LED that is positioned at the foot 216 of the teddy bear to alert the user.

Typically, the batteries for the personal messaging device 110 should last for 5 days between charges at the rate of 1 hour of playback use and 5 polls to the server 130 per day. To conserver power in the personal messaging device 110, the microcontroller 230 shuts down the device 110 between server polling or user activity to conserve energy. The personal messaging device 110 is able to wake up from a suspended state via a “Time of Day” (TOD) alarm. There is also a power switch 294 in line with the battery supply 296, which is used to turn on/off the personal messaging device 110. The microcontroller 230 monitors the battery voltage when switched on and lights an LED 217 to warn when the personal messaging device is running low (e.g., less than 1 hour running time).

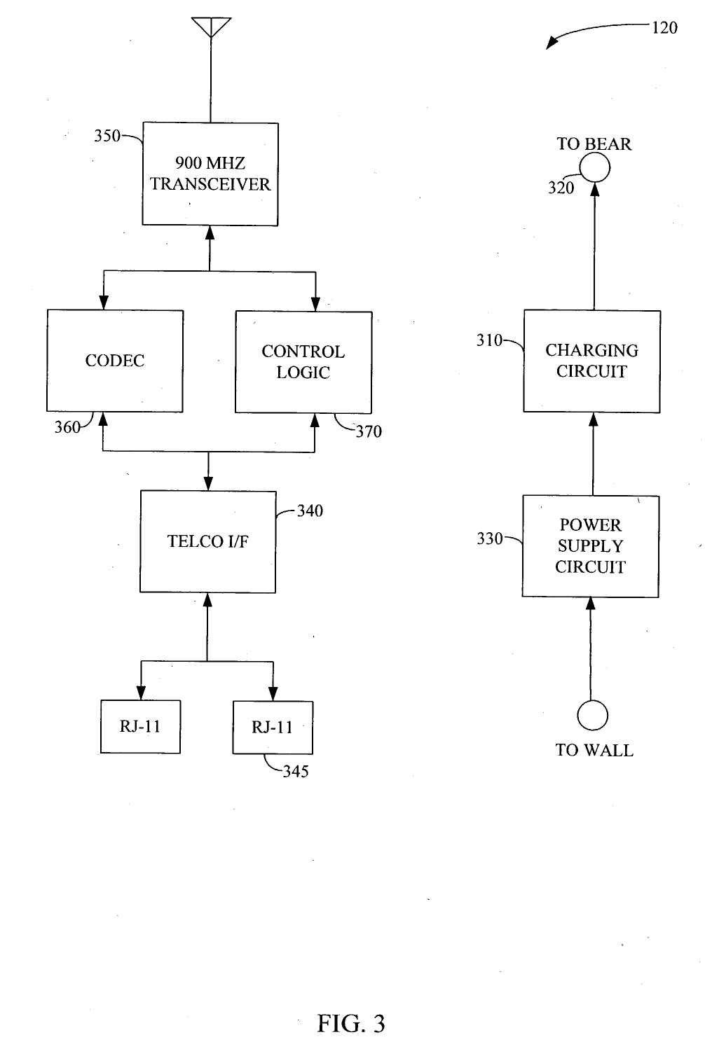

A shown in FIG. 3, one embodiment of the base station unit 120 also has a battery charging circuit 310 and a charger jack 320 for connecting the personal messaging device 10. The charging circuit 310 provides a charge for the power supply 296 of the personal messaging device 110. This charging circuit 310 also includes a power supply 330 for the base station 120. The charger jack 320 is used to recharge the batteries in the personal messaging device 110 when the rechargeable batteries are used. There may also be indicators on the base station 120 comprising a power LED and a charging indicator LED.

The base station unit 120 functions as a telephone line interface 340 for the personal messaging device 110 that receives and sends telephone signals through a telephone line. In particular, the base station unit 120 is an interface for the RF section 270 of the personal messaging device 110 to the PSTN network 140. The base station unit 120 has a pair of RJ-11 jacks 345 to allow for daisy chaining the unit 120 in line with an existing telephone. Audio content is delivered to the personal messaging device 110 via an RF link 125 between the personal messaging device 110 and the base station unit 120. Specifically, the base station 120 receives electrical signals through the telephone line from the messaging server 130 and converts these signals to RF signals which are transmitted to the RF section 270 of the personal messaging device 110.

Note, no real-time user-server phone link is established for this embodiment of the invention. Accordingly, all audio played through the speaker has been stored before use. This also means that voice messages are required to travel over the RF link 125 before being saved on the personal messaging device 110. Thus, the quality of the RF link 125 is very important, since once audio content is delivered, relocating the personal messaging device 110 relative to the base station unit 120 will not improve audio quality. Therefore, a 900 MHz digital air interface 350 is used to deliver this quality with a sufficient range to satisfy this requirement. Further, to provide added security, encryption 360 may be used. In other embodiments, alternative RF frequency transmission techniques may be employed using the 2.4 GHz frequency band or digital spread spectrum (DSS) or analog transmission techniques, among others. Control logic 370 defines how the transceiver 350 operates with the telephone line interface 340.

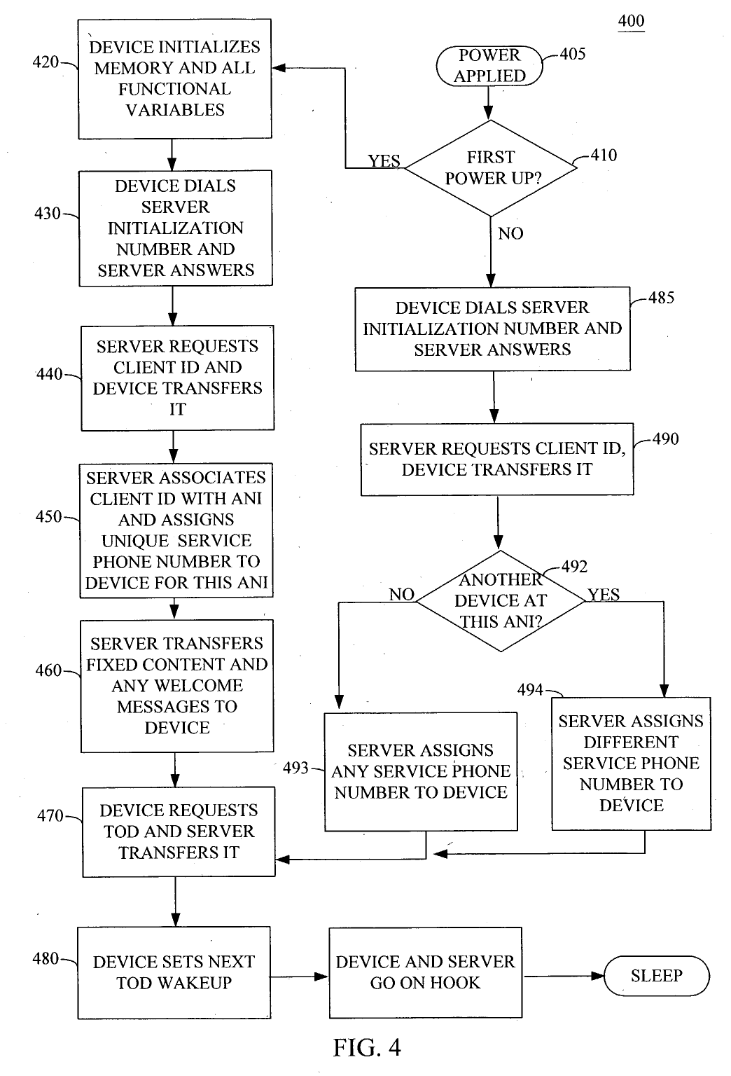

Referring now to FIG. 4, the operation 400 for one implementation of the personal messaging system 100 including the personal messaging device 110 and messaging server 130 is described when the personal messaging device 110 is powered up. The power supply of the personal messaging device 110 is triggered by an on/off switch 294. After the power is turned on, in step 405, the personal messaging device 110 determines whether it has been powered up before, as represented in step 410. This is done by examining the state of a variable located in the non-volatile memory 250 of the device 110 which will be a particularly defined value if the device has been powered up before.

If the personal messaging device 110 has not been powered up before, the personal messaging device 110 initializes memory and functional variables stored in memory, as depicted in step 420. To do so, the personal messaging device 110 connects to the remote messaging server 130 over the PSTN network 140 by calling a Server Initialization Number that is permanently stored in flash program memory 250 inside the device 110, as represented in step 430.

The personal messaging device 110 uses the Server Initialization Number the first time it is turned on and any other time that it is turned on after losing its power source, such as when the batteries are replaced, when the personal messaging device is turned off, or when the personal messaging device is manually reset. If the personal messaging device 110 is being used for the first time, this initialization procedure 400 allows the personal messaging device 110 to exchange some data, including the client ID, with the messaging server 130 to identify it properly and to get some functional variables loaded, as shown in steps 440-450.

Since each personal messaging device 110 has a unique client ID that is stored in the device's flash program memory 250, the messaging server 130 associates this unique client ID with the telephone number that the personal messaging device 110 is calling the messaging server 130 from. This information is stored by the messaging server 130 in a user database 135, as represented in steps 440-450, along with the ANI of the telephone number that the device 110 called from. The client ID number might also be provided to the user in a human readable format to further assure that the number is not errantly lost.

The personal messaging device 110 depends on the server 130 to set a number of initial values. One of the most important of these is the Server Phone Number. The Server Phone Number can be set to any number (e.g. a toll free 800 number) for the personal messaging device 110 to use for normal operation. Accordingly, the personal messaging device 110 can be assigned different server phone numbers as load leveling dictates or if there is more than one personal messaging device being used in a household, for example. So, different Server Phone Numbers may be assigned to different personal messaging devices 110.

When the personal messaging device 110 calls the Server Initialization Number, the messaging server 130 registers the device's phone number (that it is calling from) to a specific client ID, so that when the personal messaging device 110 later calls the Server Phone Number, the messaging server 130 will recognize the source of the call (via automatic number identification (ANI) that is associated with that Service Phone Number, for example) and only pick up if it has data to transfer. Further, the message server 130 assigns a Service Phone Number to the personal messaging device 130 that is not shared with any other device 110 that might also be associated with the same ANI. The logic (not shown) for assigning the Service Phone Number is similar to the logic employed in steps 492-494. Next, the messaging server 130 may transfer audio content to the device 110, as shown in step 460, and the time of day, as shown in step 470. After the time of day is transferred, the call is terminated.

If the personal messaging device 110 has been powered up (initialized) before, the device 110 calls the Server Initialization Number, since the device 110 could have had its batteries changed or could have moved, as shown in step 485. The messaging server 130 requests the client ID of the personal messaging device 110, as depicted in step 490, and determines if there is another device 110 that is associated with the same ANI as the calling device 110, as shown in step 492. If the ANI of the calling personal messaging device 110 is not shared with another device 110, the messaging server 130 can assign it any Service Phone Number, as shown in step 493. However, if the calling personal messaging device 110 shares an ANI with another messaging device, then the messaging server 130 assigns it a Service Phone Number that is different from the Service Phone Number assigned to the other device, as shown in step 494. In this way, all messaging devices that are assigned to a particular Service Phone Number, all have different associated ANIs. Next, the messaging server 130 transfers the time of day to the personal messaging device 110, as depicted in step 470.

The time of day (TOD) clock setting gets set whether the personal messaging device 110 has been powered on before of not, as represented in step 470. This is set based on the area code the device 110 is calling in from. The TOD clock is used to set wake-up times to poll the server 130 for messages, as depicted in step 480.

The personal messaging device 110 is able to receive two primary forms of content. First, voice messages left by parents, family and friends. Second, the ability for the same group of people to select (via a web site or an interactive voice response (IVR) application) from a library of pre-recorded material (lullabies, stories, etc). The personal messaging device 110 then utilizes a polling table setup by the server 130 such that it will initiate, typically, several routine calls per day into the server 130 (e.g. via a toll free phone number). Also, after an errant transmission attempt of data or after a successful transmission of data, the personal messaging device automatically polls the messaging server at a polling time that occurs a message waiting delay time (e.g., 10 minutes) later. For example, if the prior transmission resulted in an error, the next polling time is set a message waiting delay time after the prior transmission attempt occurred. Alternatively, if the prior transmission was successful, then the next polling time is set a message waiting delay time after the time when the successful message is played by the personal messaging device 110.

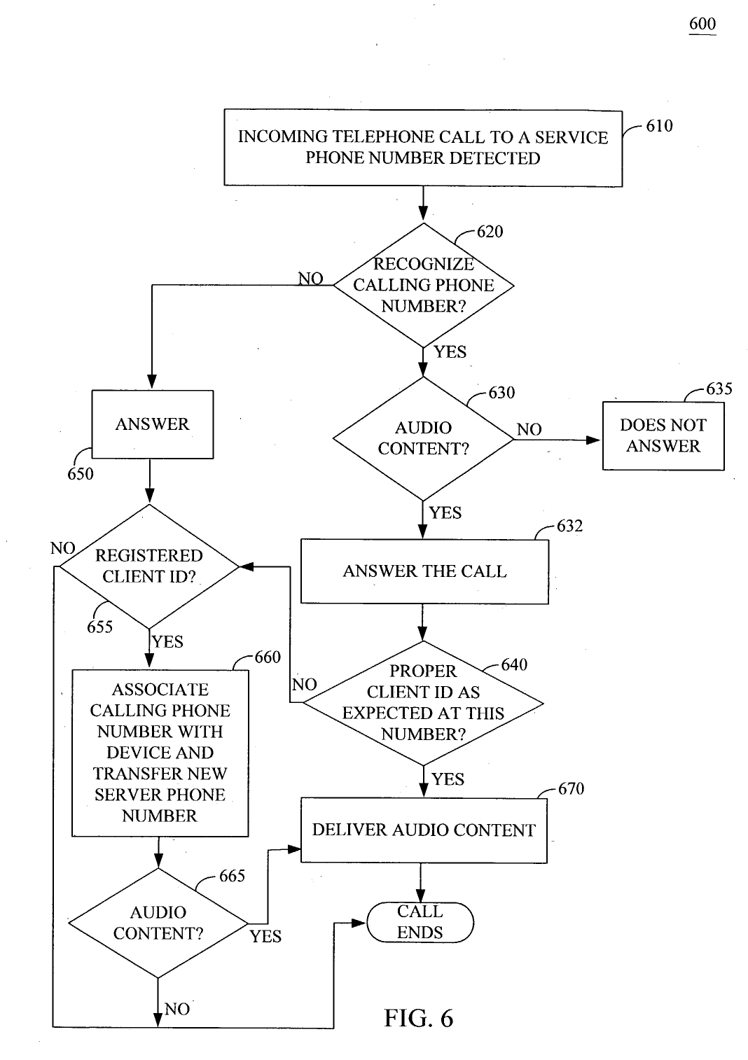

The messaging server 130 determines (based on the automatic number identification (ANI) of the incoming call) if there are any messages or stories for any bear(s) 110 registered at that number and only answer the incoming call if there is a message or story pending. If there is a message or story pending, the messaging server 130 answers the call and issues a series of DTMF tones which the personal messaging device 110 will recognize to determine the type of audio content that is pending. Then, the messaging server 130 begins transmission of the audio content to the personal messaging device 110. When the transfer is complete (barring interruption or an error in transmission), the bear 110, in this embodiment, giggles (there is also a message pending LED that is turned on) if the bear 110 is not in “sleep” mode. This process is later discussed in reference to FIG. 6.

In some preferred embodiments of the invention, the messaging server 130 has an interactive voice response (IVR) interface for generating audio content for a particular personal messaging device 110. The IVR interface allows connectivity to messaging server 130 and its database(s) 135 and can be used to read information to and write information from to the server/database. The IVR interface allows users to interact with the messaging server 130 through dual tone multi-frequency (DTMF) dialing, human speech, a web page, etc., by prompting the user to generate or select audio content for delivery to a particular personal messaging device 110.

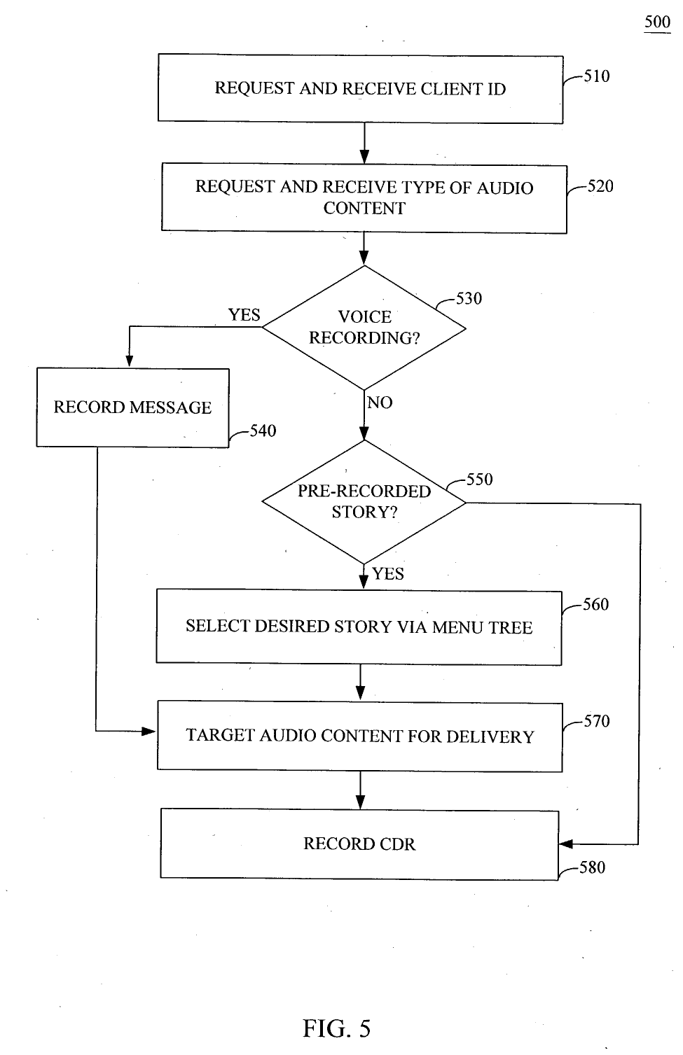

In a preferred embodiment, for example, the messaging server 130 has an IVR interface where a person places a call to an 800 number and subsequently goes through a navigation tree to leave messages or leave preset content (lullabies or stories, etc) to be delivered to the toy. During this process 500, as shown in FIG. 5, the person is asked for the client ID of the personal messaging device that the audio content is to be delivered to and the type of audio content (e.g. voice recording or a pre-recorded story) that the person wants to generate, as shown in steps 510-520. If the person selects to leave a voice recording, then the person is prompted to leave a voice recording, as shown in steps 530-540. If the person selects a pre-recorded story, then the person is prompted to select a story from a menu tree by author, category, title, etc, as depicted in steps 550-560. In step, 570, after the selection is made, the selected audio content will be targeted by the messaging server 130 for delivery to the personal messaging device 110. The date of delivery of the selected audio content is one of several other options that a person may be able set via the IVR interface, for example. During the IVR process 500, the messaging server 130 records a call detail record (CDR) capturing the automatic number identification (ANI), time/date, duration of call, content selected, etc. for billing and tracking purposes, as depicted in step 580. In different embodiments of the invention, the IVR interface may be implemented in software or hardware logic or also may be presented by a live operator.

It is intended that the personal messaging device 110 has three play patterns. First, anyone who has the client ID for the device 110 and the telephone number to call the IVR system on the messaging system 130 can call the special telephone number from anywhere in the country (for a per minute charge or for a set monetary value, for example) and send the user a message in their own voice.

The second play pattern is access to a group of stories and lullabies, for example, that are stored on the message server 130. The parent or another adult with the bear's client ID can use the telephone or internet to access the list of stories and lullabies and (for a nominal charge each, for example) select one for delivery to the bear 110. These stories and lullabies can be in character and singer voices and cover a variety of content appropriate for various age children.

The third play pattern is a group of short phrases that are permanently stored inside the bear 110 that allows the child to squeeze the bear's paw 212, for example, and randomly hear one to twenty sayings, jingles or phrases. This feature can be adjusted to segment the bears into several age groups with content appropriate to children of different ages from infants to toddlers to pre-school children.

The messaging server 130 determines if it has any data for the personal messaging device 130 and transfers it at the times that the personal messaging device 110 polls the messaging server 130. Data can be either content (audio data that the end user listens to) or configuration (digital data that is used to set up the personal messaging device 110) data. The messaging server 130 can send multiple messages to the personal messaging device or simply send an end of session command and go on hook when the personal messaging device 110 signals that it has received all the data in the current message correctly. Software controls in the personal messaging device 110 operate on the data and perform whatever function is necessary to sustain the play pattern.

To retrieve audio content from the messaging server 130 to the personal messaging device 110, the personal messaging device 110 polls the messaging server 130 at preset times. These times may be adjustable so that, for example, you may have up to 20 polls a day that are preset. As previously discussed, the personal messaging device 110 calls the messaging server 130 using the 800 Server Phone Number that is stored in the personal messaging device's 110 memory 250.

Referring now to FIG. 6, an implementation 600 of the process that the messaging server 130 follows to answer an incoming call to a Service Phone Number from the personal messaging device 110 is shown. In step 610, an incoming call is detected at the messaging server 130. In step 620, the messaging server 130 checks to see if the messaging server 130 recognizes the telephone number (ANI) that is originating the call to that Service Phone Number.

As previously discussed, when the personal messaging device 110 is first registered with the messaging server 130, the messaging server 130 associates the unique client ID of this device 110 with the calling phone number from which the personal messaging device 110 called the messaging server 130. The messaging server 130 is able to obtain the phone number information since the personal messaging device calls an 800 number. The messaging server 130 stores the phone number information and the client ID in the database 125. After the messaging server 130 recognizes that the incoming call is from a telephone number contained in the database, it answers the telephone call if there is audio content in the database 125 for the personal messaging device 110 associated with that telephone number, as shown in steps 630-632. Else, the messaging server 130 does not answer the call as depicted in step 635.

After answering the call, the messaging server 130 verifies that the client ID of the calling personal messaging device 110 is the same client ID that the messaging server 130 associates with the ANI, as shown in step 640. If the client ID is verified, then the messaging server 130 determines if there is any audio content that should be transferred to the personal messaging device 110.

If the messaging server 130 does not recognize the source of the incoming call, it answers the incoming call, as depicted in step 650, and requests the client ID of the calling messaging device 110 to determine if the client ID for this device has been registered (initialized) previously, as shown in step 655. If the calling device has, then the messaging server 130 associates the new ANI with the client ID of the calling messaging device 110 and transfers a new Server Phone Number, as depicted in step 660. Then, the messaging server 130 determines if there is any audio content that should be transferrred to this personal messaging device 110, as represented in step 665.

If the messaging server 130 does have audio content for the personal messaging device 110, the server 130 delivers audio content to the personal messaging device, as represented in step 670. For example, if there are three audio messages stored on the messaging server 1310 for the personal messaging device 110, the messaging server 130 delivers the three messages to the personal messaging device 110 one at a time. The first of these messages on the messaging server 130 is delivered to the personal messaging device 110 over the PSTN network 140 and stored in memory 250 within the personal messaging device 110. Referring again to FIG. 1, after the message is successfully stored within memory 250, the microcontroller turns on a LED in the paw 210, 212 of the bear to alert the user that a new message is ready to be played. After the user plays this new message, then the personal messaging device 110 soon polls the messaging server 130 again to download another message that is on the messaging server 130 for the personal messaging device 110. The personal messaging device 110 then awaits a message waiting delay time before it polls the messaging server 130 again, since the personal messaging device 110 just received a message.

So, if the messaging server 130 has many audio messages or audio stories, for example, for a particular personal messaging device 110, the personal messaging device 110 polls the server 130 more often so that the user can access this audio content quicker. When there is no longer any audio content on the messaging server 130 for the personal messaging device 110, and the messaging server 130 does not answer an incoming call from the device 110, the personal messaging device 110 reverts back to checking for audio content at the next scheduled poll time. Note, there is never an incoming telephone call to the personal messaging device. The personal messaging device always initiates telephone communications.

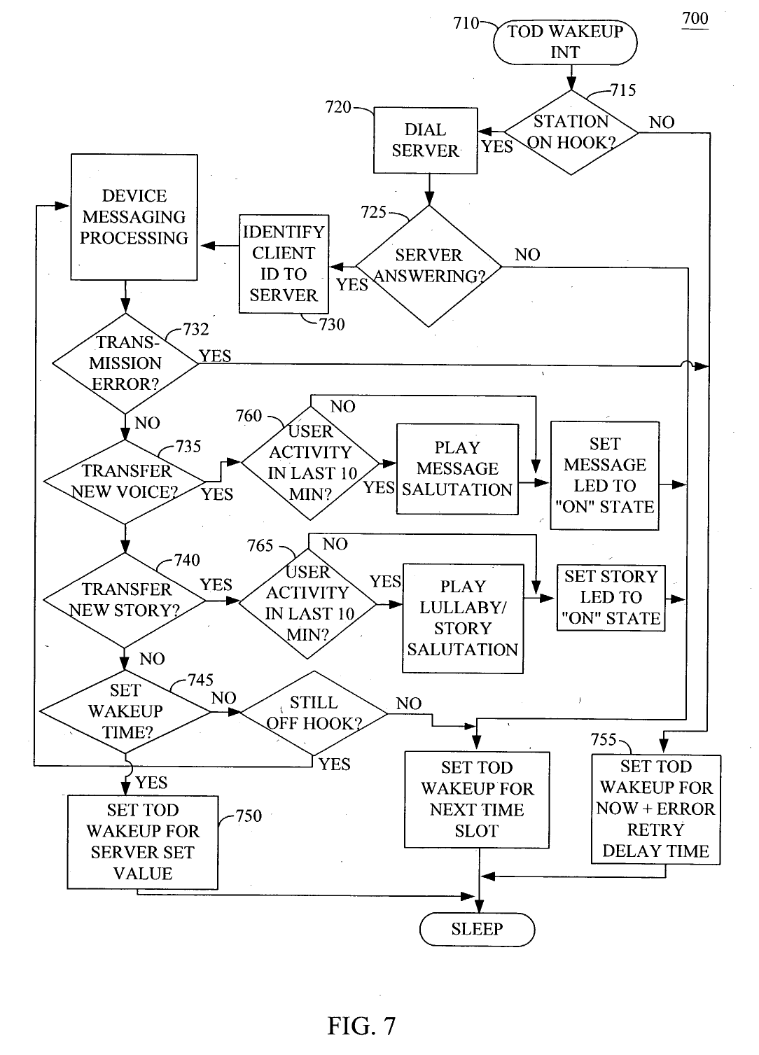

Next in FIG. 7, an implementation 700 of this polling process is explained in more detail. The routine polling times that the personal messaging device 110 regularly checks for audio content on the messaging server 130 per are determined by the messaging server 130. The only way that the personal messaging device 110 initiates communication with the messaging server 110 and receives audio content is by these preset polling times and other polling times set after errant data transmissions, successful data transmissions, or interrupted polling attempts, for example.

There may be some flexibility in the polling times based on whether the personal messaging device 110 was previously successful in downloading a prior audio content, such as a message, a story, or a lullaby. As discussed earlier, the personal messaging device 110 may poll soon thereafter until no messages are left on the messaging server 130 for the device 110.

For example, the messaging server 130 may determine polling times according to an algorithm that optimizes the times that the personal messaging device 110 and other similar personal messaging devices check for audio content with the messaging server 130 so that the messaging server 130 is not overloaded at one time. Further, the messaging server 130 may set polling times to occur at the most probable times that audio content may be available for the personal messaging device 110. If the messaging server 130 recognizes that audio content is generated for a particular device 110 in the late afternoon, then the messaging server 130 may dynamically set a polling time to also occur in the late afternoon so that the pending audio content may be delivered to the personal messaging device 110 in a quick and efficient fashion.

Referring now to FIG. 7, the personal messaging device 110 is driven by time of day wakeup interrupts so that after the personal messaging device 110 goes to sleep in a suspend state, the time of day wakeup alarm (“TOD alarm”) goes off and causes an interrupt, as shown in step 710. This causes the personal messaging device 110 to wake up and perform a service routine for the TOD interrupt which is to go poll the server 130. Accordingly, the personal messaging device 110 checks to see if there is an open telephone line upon which to dial the messaging server, as shown in step 715.

If there is, the personal messaging device 110 calls the messaging server 130, as depicted in step 720. If the messaging server 130 answers, in step 725, as previously discussed, the personal messaging device 110 identifies itself via its unique client ID to the messaging server 130 and downloads audio content (if available) that is designated for the personal messaging device 110, as shown in steps 730-740. Also, the messaging server 130 may request information from and/or change information in the personal messaging device 110 during the polling call. Next, the personal messaging device 110 sets the next polling time (“wakeup time”) from the server initialized polling table stored in RAM 255, as represented in steps 745-750.

All the audio content or messages that are transferred to the personal messaging device 110 from the messaging server 130 are preceded by headers that provide error detection and error correction capabilities for the personal messaging device 110 so that it is assured of receiving the header and the message properly. When an error is detected, the personal messaging device 110 directs the server 130 to resend the message header or data. If after several attempts (“re-try limit”) data transfer is still unsuccessful, the personal messaging device 110 goes on hook and discards whatever part of the current message is in process. The server 130 has a similar feature. This prevents runaway conditions where the device is actively using a communication channel, but there is no data being successfully transferred.

Whenever the communication channel is open, the personal messaging device 110 monitors activity for a timeout condition. If no activity occurs on the communication channel for longer than the timeout setting, the personal messaging device 110 goes on hook and discards whatever part of the current message has been stored in memory. The server 130 has a similar feature. This prevents stall conditions where no device 110 is actively using the channel, and all other devices 110 are waiting.

If a polling attempt results in an error, the personal messaging device 110 attempts another poll a preset time after the last attempt, as shown in steps 732 and 755. For example, if someone has the phone off the hook during the time that the personal messaging device 110 is set to establish communication with the messaging server 130, the personal messaging device 110 will try again to establish communication a set time (“error retry delay time”) after its failed time (e.g. 15 minutes). Note, that parameters such as the error retry delay time, polling times, and message waiting delay times, for example, are fully configurable by the messaging server 130 and can be changed as desired.

In some embodiments of the invention, it is important that the personal messaging device 110 does not receive any audio contents while a user is playing back audio content on the personal messaging device 110. This is due to the technology limitation of not being able to read and write to memory at the same time. Accordingly, the personal messaging device 110 is set up to not poll the messaging server 130 whenever the child is playing with the toy. The personal messaging device 110 will wait for the child to stop playing with the toy and then polls the messaging server 130 after the message waiting delay time, as represented in steps 260-265. In this way, a conflict of operations is avoided between trying to read data out of audio memory 250 at the same time that data is trying to be written into memory 250. However, as future technology allows, it is contemplated that other embodiments of the invention will allow the transfer of audio content to the personal messaging device while audio content is also being played.

In one preferred embodiment, user input on the personal messaging device has the highest priority among the operations of the device. Generally, if some process is going on and a user hits a button, 210, 212, 214, the button press gets serviced. Accordingly, if a user is in the middle of a message being played back and presses the paw button again, 210, 212, 214, the personal messaging device 110 starts playing the next message. The personal messaging device assumes that the most recent button press is the highest priority of operation.

Therefore, if the personal messaging device 110 is in the middle of polling and downloading audio data, and the personal messaging device 11 receives a button 210, 212, 214 press, the personal messaging device 110 stops that audio download and schedules a polling attempt to occur after the message waiting delay time. The personal messaging device then leaves the space in memory 250 that was allocated for the interrupted audio data vacant. This partially filled space in memory 250 may then be skipped over as the personal messaging device 110 rotates through the audio content stored in memory.

As previously expressed in one embodiment, the audio memory 250 is nonvolatile and is divided into three partitions. The first partition is for personal messages (“Message Memory”) which are generated by someone leaving a voice recording on the messaging server 130 and then being delivered to the personal messaging device 110. The second partition is for lullabies and stories that feature preset content. For this type of audio content, a person calls the messaging server 130 and is prompted by the IVR system to select the preset audio content that the person would like to deliver to a particular personal messaging device 110. When the device 110 polls the messaging server 130, the messaging server delivers the lullaby or story and it is stored in this second partition.

In the third partition of memory, fixed audio content is stored. For example, short audio phrases, salutations, or quips are contained such as “Lets play,” and “It's a great day today” so that the toy always has random audio content to play via a child hugging the bear, for instance. Typically the audio content in the third partition is downloaded once and not changed. Fixed audio content may be pre-loaded into memory at time of manufacture or may be transferred from the messaging server at time of registration to suit user preferences.

Playback of the fixed content is random with the only rule to prevent the same phrase from being played twice consecutively. In one embodiment of the invention, the audio data for the third partition comprises comprise one minute length of data. The one minute length further comprises 20 separate messages. Each message of a length of three seconds.

In some preferred embodiments where the device 110 is contained in a plush toy animal, the fixed audio content type of salutation is a giggle that the client performs upon receiving a new message if in “active” mode. Concerning active mode, the personal messaging device 110 has a timer which is used to define the two states of functionality of the personal messaging device 110. The first is active mode which allows the personal messaging device 110 to play a salutation on receipt of a new message, and is a result of button presses or playback of content.

The sleep timer is reset on power-up, the occurrence of a button press, or the completion of message or content playback. If the timer is allowed to reach 10 minutes, the personal messaging device 110 enters the “sleep” mode, which allows polling, but no audio salutation is played on a new message receipt. The active mode is re-entered as soon as a button is pressed. This allows the personal messaging device 110 to enter a state where it will not be disturbing people by making noise whenever a message is received if no one is using it at the time.

In total, audio memory 250 can hold 15 minutes of audio data in a preferred embodiment of the invention. Since all audio content is prestored in the personal messaging device 110 before it is ever played, a user is able to play messages and other audio content when the user is out of reach of the base station 120.

A pin-accessible button 215 is used to purge the downloadable sections (message and lullaby/story) of memory if unwanted material gets downloaded. In this way, a user can remove any offensive message. All configuration memory must also be non-volatile. A small partition in the flash should be set aside for the configuration data, so that it will be static across a battery failure. If possible, the client ID should be in a write-protected portion of the non-volatile memory 250, or at least the microcontroller 230 should be sufficiently encumbered from altering that memory to prevent an accidental write to the location.

As mentioned earlier, a preferred embodiment of the personal messaging device 110 has three buttons and three LEDs located in the paws, foot, and belly, 210, 212, 214, 216. Each button is associated with a particular partition of memory and is used to play messages from that partition. One LED serves as a low power indicator, and the other two serve as “new message waiting” indicators for the two downloadable partitions. To play a particular type of message, the user activates a particular button that triggers the microcontroller 230 to play that type of message from memory 250.

For example, by squeezing one paw, 210, 212, you may play a personal message recording, and by squeezing the other paw, 210, 212, you may play a stored lullaby or story. Audio content is stored in memory 250 until the audio content has been played and until memory space needs to be freed up for new audio content. For example, if there are 5 messages stored in the first partition, and the user presses the appropriate paw, 210, 212, the personal messaging device 110 plays the first message. When the paw, 210, 212, is pressed again, the personal messaging device 110 plays the second message, and if the paw, 210, 212, is pressed again, it plays the third message, and so on until all the messages have been played. After all the messages have been played, the personal messaging device 110 cycles through the messages again and plays them over.

Now, if the fifth message is the oldest one, and a new message is set to be delivered to the personal messaging device 110 but there is not enough room in the associated partition, the personal messaging device 110 discards the oldest message (i.e. the fifth message). However, the device 110 may also discard the next oldest message if room is still needed in memory to store the new message.

Therefore, a message remains in memory 250 as long as there is room for it, and it will get pushed out by new data. The personal messaging device 110 only polls for new data when all the messages in memory have been listened to. The device 110 does not poll if there is a message that has not been listened to. Accordingly, an unlistened to message or audio story does not get deleted before it is listened to by the user.

The length of incoming data is stored in a header contained in the audio data. The header has the length of the incoming data in it, so that the personal messaging device 110 may free up that amount of memory 250. After the memory is freed up, the audio data is received from the server 130 and stored in that free section of memory. Further, the personal messaging device 110 adds the new audio data to the playlist for the personal messaging device 110 and deletes from the playlist the audio data that was deleted from memory 250. Also, the toy 110 sets the new message to the top of the playlist so that it will be the next message played by the personal messaging device 110 upon the respective user input. This is true for personal messages and lullabies and stories.

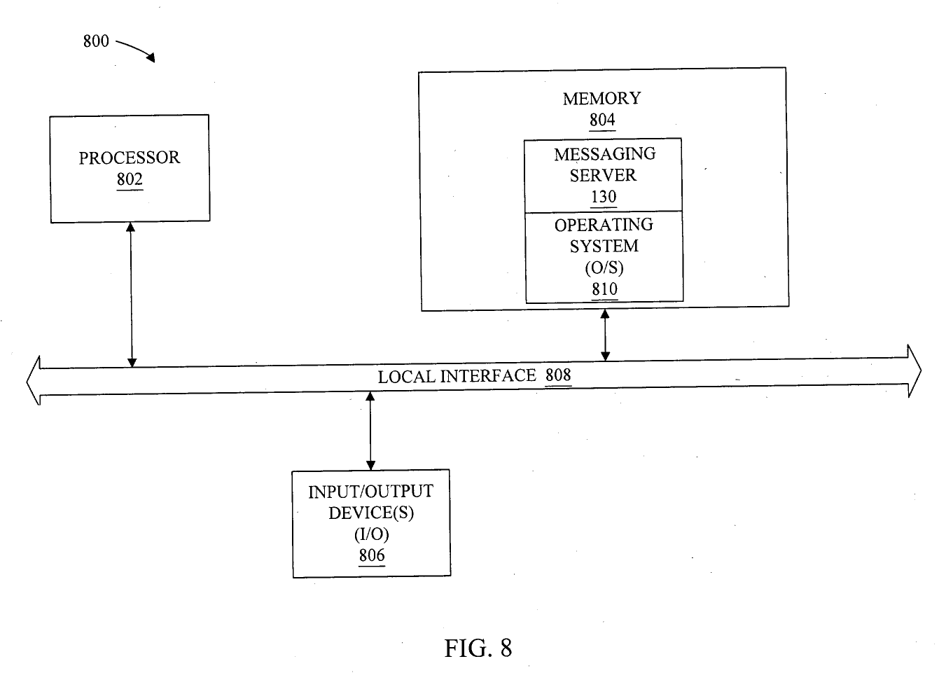

The personal messaging device 110 and messaging server 130 of a representative embodiment of the present invention can be implemented in software, firmware, hardware, or a combination thereof. Preferably, the messaging server 130 is implemented in software, as an executable program and is executed by a digital computer, such as a personal computer, workstation, minicomputer, or mainframe computer. An example of a digital computer that can implement the messaging server 130 of one preferred embodiment of the present invention is shown in FIG. 8.

Generally, in terms of hardware architecture, as shown in FIG. 8, the computer 800 includes a processor 802, memory 804, and one or more input and/or output (I/O) devices 806 (or peripherals) that are communicatively coupled via a local interface 808. The local interface 808 can be, for example but not limited to, one or more buses or other wired or wireless connections, as is known in the art. The local interface 808 may have additional elements, which are omitted for simplicity, such as controllers, buffers (caches), drivers, repeaters, and receivers, to enable communication. Further, the local interface may include address, control, and/or data connections to enable appropriate communication among the aforementioned components.

The processor 802 may be a hardware device for executing software that can be stored in memory 804 such as the IVR interface application. The processor 802 can be any custom made or commercially available processor, a central processing unit (CPU) or an auxiliary processor among several processors associated with the computer 800, and a semiconductor based microprocessor (in the form of a microchip) or a macroprocessor.

The memory 804 can include any one or combination of volatile memory elements (e.g., random access memory (RAM, such as DRAM, SRAM, etc.)) and non-volatile memory elements (e.g., ROM, hard drive, tape, CDROM, etc.). Moreover, the memory 804 may incorporate electronic, magnetic, optical, and/or other types of storage media. Note that the memory 804 can have a distributed architecture, where various components are situated remote from one another, but can be accessed by the processor 802.

The software in memory 804 may include one or more separate programs, each of which comprises an ordered listing of executable instructions for implementing logical functions. In the example of FIG. 8, the software in the memory 804 includes the messaging server 130 and an operating system (O/S) 810. Correspondingly, the software could also include the IVR application (not shown). The operating system 810 essentially controls the execution of other computer programs, and provides scheduling, input-output control, file and data management, memory management, and communication control and related services.

The messaging server 130 may be a source program, executable program (object code), script, or any other entity comprising a set of instructions to be performed. If the messaging server 130 is a source program, then the program needs to be translated via a compiler, assembler, interpreter, or the like, which may or may not be included within the memory 804, so as to operate properly in connection with the O/S 810. Furthermore, the messaging server 130 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 806 may include input devices, for example but not limited to, a keyboard, mouse, scanner, digital camera, multi-function device, digital sender, microphone, etc. Furthermore, the I/O devices 806 may also include output devices, for example but not limited to, a printer, display, etc. Finally, the I/O devices 806 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 800 is a PC, workstation, or the like, the software in the memory 804 may further include a basic input output system (BIOS) (omitted for simplicity). The BIOS is a set of essential software routines that initialize and test hardware at startup, start the O/S 810, and support the transfer of data among the hardware devices. The BIOS is stored in ROM so that the BIOS can be executed when the computer 800 is activated.

When the computer 800 is in operation, the processor 802 is configured to execute software stored within the memory 804, to communicate data to and from the memory 804, and to generally control operations of the computer 800 pursuant to the software. The messaging server 130 and the O/S 810, in whole or in part, but typically the latter, are read by the processor 802, perhaps buffered within the processor 802, and then executed.

When the messaging server 130 or messaging device 110 is implemented in software, as is shown in FIGS. 4-7, it should be noted that the messaging server 130 or personal messaging device 110 can be stored on any computer readable medium for use by or in connection with any computer related system or method. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic); an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the messaging server 130 or device 110, is implemented in hardware, the messaging server 130 or device 110 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Note, any process descriptions or blocks in the above-described flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The enhanced messaging capabilities of the above-described embodiments of the present invention advantageously leads to an improved system and method for reliably and optimally delivering messages to a user, such as a young child, via a personal messaging device. It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. For example, it is contemplated that the number of polling times per day may be adjusted for those users who receive numerous messages throughout a day. Also, it is contemplated that the personal messaging device may be in a variety of forms and may be intended for users of a variety of ages. All such modifications and variations are intended to be included herein within the scope of this disclosure and the present invention and protected by the following claims.

Therefore, having thus described the invention, at least the following is claimed:

1. A system for delivering audio content to a user over a communication network, comprising:
a base station connected to the communication network;
a personal messaging device communicatively linked to the base station, wherein the personal messaging device polls for the presence of audio content designated for the personal messaging device and receives the audio content if the audio content is present.

2. The system of claim 1, wherein the personal messaging device and the base station communicate via a 900 MHz RF link.

3. The system of claim 1, wherein the personal messaging device and the base station communicate via a 2.4 GHz RF link.

4. The system for claim 1, wherein a unique client ID is associated with the personal messaging device.

5. The system of claim 1, wherein the audio content comprises voice recordings.

6. The system of claim 1, wherein the audio content comprises prerecorded content.

7. The system of claim 1, wherein the personal messaging device is contained inside a plush doll.

8. The system of claim 1, wherein the communication network is a PSTN network.

9. The system of claim 1, further comprising:
a messaging server connected to the communication network, the messaging server receiving polling communication from the personal messaging device and sending the audio content to personal messaging device if designated audio content is present.

10. The system of claim 9, the personal messaging device comprising:
a transmitter portion for initiating communication with the messaging server;
a receiver portion for receiving the audio content from the messaging server; and
a memory portion for storing the audio content in the personal messaging device.

11. The system of claim 10, the personal messaging device further comprising:
an audio section for playing the audio content;
a controller to activate the playing of audio content; and
a user interface to command the controller to activate the playing of audio content.

12. The system of claim 10, the personal messaging device further comprising:
a memory purge interface for enabling a user to delete the audio content in the memory portion.

13. The system of claim 10, the personal messaging device, further comprising:
logic configured to:
determining the audio content to be of a particular type; and
storing the particular type of audio content to a particular area in the memory portion.

14. The system of claim 1, further comprising:
a database that is accessible by the messaging server for the purpose of storing the audio content.

15. The system of claim 9, the messaging server further comprising:
logic configured to:
upon receiving an attempt at polling communication from the personal messaging device, recognizing the personal messaging device attempting polling communication; and
establishing communication if audio content is present for the personal messaging device.

16. The system of claim 15, wherein the polling communication is attempted at an alarm time set by the messaging server.

17. The system of claim 16, wherein the alarm time is adjustable depending on whether prior audio content had been delivered at the previous alarm time.

18. The system of claim 16, wherein the alarm time is adjustable depending on whether the transmission of prior audio content had been unsuccessful.

19. The system of claim 9, the messaging server further comprising:
an interactive interface for determining particular audio content that is stored by the messaging server for a particular personal messaging device.

20. The system of claim 19, wherein the interactive interface is accessed over a telephone network.

21. The system of claim 19, wherein the interactive interface is accessed over the Internet.

22. A system for delivering audio content to a user over a communication network, comprising:
means for storing audio content designated for a particular user; and
means for initiating communication with the means for storing, the means for initiating receiving designated audio content from the means for storing if the designated audio content is present.

23. The system of claim 22, further comprising:
means for generating audio content designated for the particular user that is stored by the means for storing.

24. A method for delivering audio content to a young child over a communication network, comprising:
storing the audio content in a storage system;
determining if the audio content is present for a particular user upon a messaging device of the user polling the storage system via the communication network; and
delivering the audio content to the messaging device of the particular user, via the communication network, upon determining that the audio content is present for the particular user.

25. The method of claim 24, further comprising:
determining the audio content that is stored in the storage system for the particular user.

26. The method of claim 25, the determining the audio content step further comprising:
providing a menu offering different selections of audio content; and
selecting a particular audio content from the menu.

27. The method of claim 26, the determining the audio content step further comprising:
generating a voice recording.

28. The method of claim 27, further comprising:
setting an alarm time for the messaging device to poll the storage system.

29. The method of claim 28, wherein the alarm time is adjustable depending on whether prior audio content had been delivered at the previous alarm time.

30. The method of claim 29, further comprising:
after delivering the audio content, storing the audio content in memory in the messaging device; and
playing the audio content in memory upon user command.

31. The method of claim 30, the playing step further comprising:
interrupting the receiving of audio content from the storage system to play stored audio content in memory.

32. The method of claim 24, further comprising:
after delivering the audio content, determining the audio content to be of a particular type; and
storing the particular type of audio content to a particular area in memory in the messaging device.

33. The method of claim 32, further comprising:
removing portions of old audio content in memory in a particular area to make room for-new audio content.

34. The method of claim 33, further comprising:
playing a particular type of audio content upon user command.

35. The method of claim 34, the playing step further comprising:
receiving a user command to play different type of audio content in memory; and
interrupting the playing of the particular type audio content to play the different type of audio content.

36. The method of claim 24, further comprising:
alerting the particular user that audio content has been received on the messaging device.

37. A computer readable medium having a computer program for delivering audio content to a young child, the program for performing the steps of:
storing the audio content in a storage system;
determining if the audio content is present for a particular user upon a messaging device of the user polling the storage system via the communication network; and
delivering the audio content to the messaging device of the particular user, via the communication network, upon determining that the audio content is present for the particular user.

38. The medium of claim 37, the program further comprising the step of:
determining the audio content that is stored in the storage system for the particular user.

39. The medium of claim 38, the determining the audio content step further comprising:
providing a menu offering different selections of audio content; and
selecting a particular audio content from the menu.

40. The medium of claim 39, the determining the audio content step further comprising:
generating a voice recording.

41. The medium of claim 37, the program further comprising:
setting an alarm time for the messaging device to poll the storage system.

42. The medium of claim 41, wherein the alarm time is adjustable depending on whether prior audio content had been delivered at the previous alarm time.

43. The medium of claim 37, the program further comprising:
after delivering the audio content, storing the audio content in memory in the messaging device; and
playing the audio content in memory upon user command.

44. The medium of claim 43, the playing step further comprising:
interrupting the receiving of audio content from the storage system to play stored audio content in memory.

45. The medium of claim 37, the program further comprising:
after delivering the audio content, determining the audio content to be of a particular type; and
storing the particular type of audio content to a particular area in memory in the messaging device.

46. The medium of claim 45, the program further comprising:
removing portions of old audio content in memory in a particular area to make room for new audio content.

47. The medium of claim 45, the program further comprising:
playing a particular type of audio content upon user command.

48. The medium of claim 47, the playing step further comprising:
receiving a user command to play different type of audio content in memory; and
interrupting the playing of the particular type audio content to play the different type of audio content.

49. The medium of claim 37, the program further comprising:
alerting the particular user that audio content has been received on the messaging device.
